(19) United States
(12) Patent Application Publication
(10) Pub. No.: US 2002/0133988 A1
(43) Pub. Date: Sep. 26, 2002

(54) Hand-held placard display incorporating a plurality of individual messages mounted in a circular binding fashion

(76) Inventor: Jim Spelman, Fenton, MI (US)

Correspondence Address: Douglas J. McEvoy, Gifford, Krass, Groh, Sprinkle,, Anderson & Citkowski, P.C., 280 N. Old Woodward Ave., Suite 400, Birmingham, MI, 48009, US

(21) Appl. No.: 09/814,210

(22) Filed: Mar. 21, 2001

(51) Int. Cl. G09F 21/02; G09F 7/00

(52) U.S. Cl. 40/586; 40/492

(57) ABSTRACT

A hand-held inter-auto display device for use by a driver or occupant of a vehicle and in order to communicate desired messages to the drivers or occupants of other vehicles and during specific driving situations. The device includes a support with a handle portion and an interconnecting and substantially planar display portion. The display portion has a first surface and a second oppositely facing surface defining therebetween a specified thickness. A plurality of individual and stackable sheets of material are provided, each of the sheets displaying a selected message on at least one side thereof, each of the messages being presented according to a selected content, coloring and lettering style. The sheets are pivotally bound to the planar display portion of the support so that a selected message, displayed on a first selected sheet located upon the first surface, may be rotated to abut against the second oppositely facing surface and to reveal an underlying and second selected sheet located upon the first surface and displaying a further selected message. The pivotally binding further is provided with at least one binding ring engaging through the display portion, between the first and second facing surfaces, and proximate an extending edge opposite the handle portion.

### BACKGROUND OF THE INVENTION

1. Field of the Invention

The present invention relates generally to inter-automotive or vehicle related communication devices and, more particularly, to a hand-held display device incorporating a number of individual, and preferably spiral bound, messages of sufficient size and dimension and which are mounted to a suitable display support for flashing by an operator or passenger of a vehicle to a driver or occupant of one or more other vehicles.

2. Description of the Prior Art

The prior art is well documented with various types of inter-vehicle display devices for communicating messages from the operator of one vehicle to the operators of one or more other vehicles. A professed advantage of such devices is to provide a degree of inter-vehicle communication in instances in which it would assist vehicle safety.

A first example of such a vehicle communication device is disclosed in U.S. Pat. No. 5,905,434, issued to Steffan et al., and which includes a remote control unit installed in the interior of a vehicle and a display unit located on the exterior of the vehicle. The display unit has an input from the remote control unit and an input from a vehicle interface module which in turn has inputs from the vehicle such as the braking system and the turning signal system. The remote control unit is controllable by the driver in the vehicle, the driver having a table of preset and preprogrammed messages which are selectable for presentation. Inputs to the vehicle interface module, from the vehicle signaling system, overrides the signal input from the remote control unit unless the display unit is mounted on the front of the vehicle. The driver may then select messages from the table of messages that are sequentially displayed on the remote control unit. The table of messages is stored on a flash memory in the remote unit and in a flash memory in the display unit. The table of messages in the remote unit is programmable via a USB programming port and can be further programmed via an RF signal sent to the display unit by the remote unit.

Additional examples of hand-held signaling devices are also known in the art and these include U.S. Pat. No. 5,905,441, issued to Klee et al., and U.S. Pat. No. 5,973,607, issued to Munyon. Klee teaches a device having interspersed arrays of red/amber/green LED signal lamps and a center flashing strobe lamp. A side mounted joy-stick type toggle switch on the housing is operated by the user's thumb to provide the control of the signal lamps. One position of the joy-stick button operates an on/off switch, and the other three positions each operate one of the three color arrays. A separate strobe light switch is provided and adjacent the toggle switch. The housing of the signaling device is further described and illustrated to be bowl-shaped and held in the palm of the user's outwardly extending hand. A strap extending around the back of the hand provides assistance. A battery pack is recharged through a standard socket for connection through a cord and utility plug to a power source.

The Munyon patent further discloses a hand-held programmable sign which includes a unitary “T” shaped housing having opposed front and rear sides and including an upper sign portion and a lower hand-held portion mounted midway transverse to the sign portion. A keyboard system is provided with a miniaturized keyboard processor including keys marked with indicia for letter of the alphabet, numerals, and other selected indicia is further mounted oil the hand grip for operator input. Operating keys are also mounted on the keyboard and the sign includes a miniaturized computer processor for processing input data received from the keyboard. A miniaturized light-emitting message display (preferably an LED display) is mounted on the front side of the sign portion for reading by an observer. An electrical circuit in the housing joins the keyboard system, computer microprocessor, and the light-emitting message display and which can be either internally or externally powered. An optional miniaturized monitor display system is mounted on the rear side of the sign portion and receives input data from the computer microprocessor prior to transmission of the input data so that a user can edit or verify the accuracy of the input data prior to transmission of the data to the light-emitting message display.

A plurality of additional vehicle communication devices are illustrated in the various U.S. Pat. Nos. 5,053,746, issued to Taneo; 5,574,428, issued to Groover; 4,949,071, issued to Hutchison; 4,574,269, issued to Miller; and 3,800,430, issued to Samra. In each instance, the communication device incorporates an electrically powered lamp or LED type display which is programmed to display a specific message or signal.

### SUMMARY OF THE PRESENT INVENTION

The present invention is a hand-held signal display device for use by a driver or occupant of a vehicle and in order to communicate desired messages to the drivers or occupants of other vehicles and during specific driving situations. The present invention is admittedly a “low-tech” approach to accomplishing inter-vehicle communication, however one that has been demonstrated to be very effective in accomplishing the desired communication, with the advantage that it decreases the instances of driver frustration, road rage and overall better attitudes of drivers when on the road.

The hand held display device of the present invention includes a support with a handle portion and an interconnecting and substantially planar display portion. The display portion has a first surface and a second oppositely facing surface defining therebetween a specified thickness.

A plurality of individual and stackable sheets of material are provided, each of the sheets displaying a selected message on at least one side thereof, each of the messages being presented according to a selected content, coloring and lettering style. In a preferred variant, each of the sheets of material are constructed of a semi-rigid poster board material. In the further preferred variant, the display portion and messages supported thereon are of a sufficient size and dimension so that the content of the messages are easily visible to surrounding motorists. In a preferred construction, a six inch height and a twelve inch width have found to be most effective in both the ease of manipulation of the device by the user within the vehicle, as well as being visible to occupants in the vehicle or vehicles being signaled.

The sheets are pivotally bound to the planar display portion of the support so that a selected message, displayed on a first selected sheet located upon the first surface, may be rotated to abut against the second oppositely facing surface and to reveal an underlying and second selected sheet located upon the first surface and displaying a further selected message. The pivotally binding further is provided with at least one binding ring engaging through the display portion, between the first and second facing surfaces, and proximate an extending edge opposite the handle portion.

In one variant, a pair of first and second binding rings are located at specified and spaced apart distances, each of the rings being separately attachable and disengageable from the display portion by first pivotally associated and arcuately configured portions and second pivotally associated and arcuately configured portions, a clasp extending from an end of each of the first configured portion and receivingly engaging within an aperture defined proximate an end of the second associated configured portion. In a further variant, a plurality of spiral binding portions engage through the display portion, between the first and second facing surfaces, and proximate an extending edge opposite the handle portion. An additional feature of the invention also contemplates a display mount at a specified location within the vehicle and within which may be seatingly engaged the handle portion and so that the message arrayed upon the display portion is visible to occupants of other vehicles.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the hand-held and inter-auto display device according to a first preferred variant of the present invention;

FIG. 2 is perspective view of the hand-held and inter-auto display device according to a second preferred variant of the present invention;

FIG. 3 is an environmental view and illustrating the display device mounted within a suitable vehicle location; and

FIG. 4 is a sectional view of a selected binder ring according to one preferred application of the present invention.

### DETAILED DESCRIPTION OF THE PREFERRED EMBODIMENTS

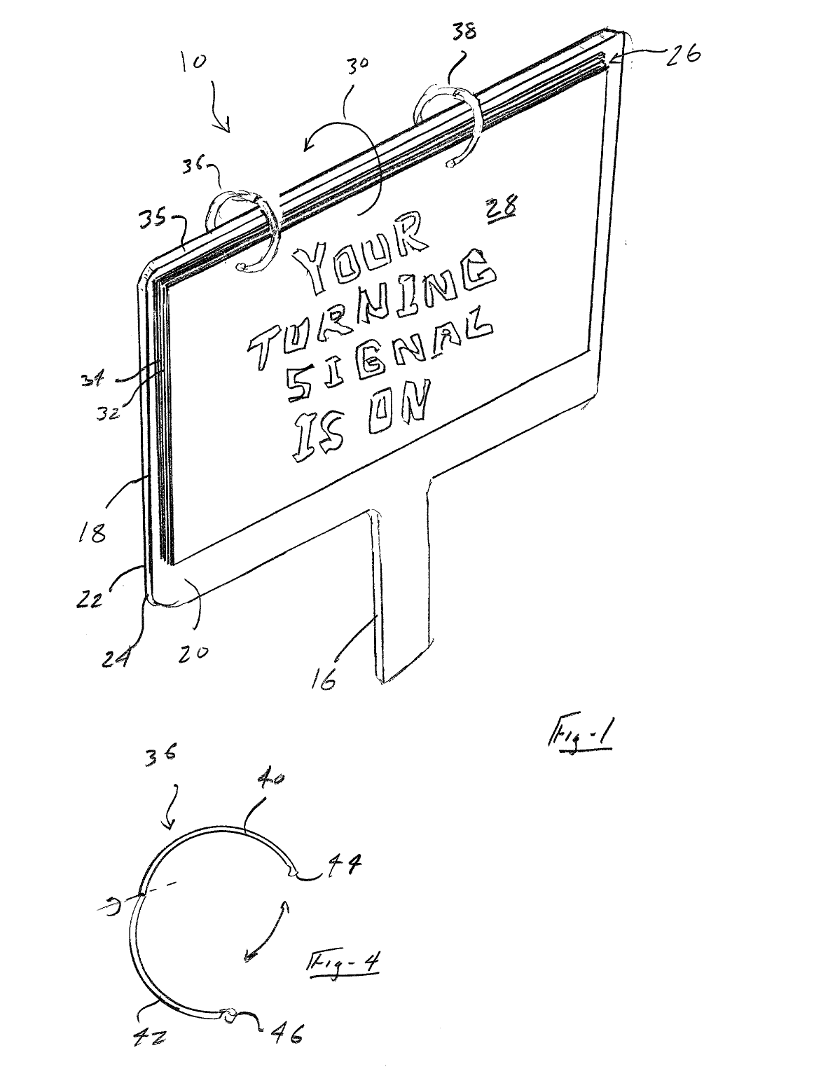

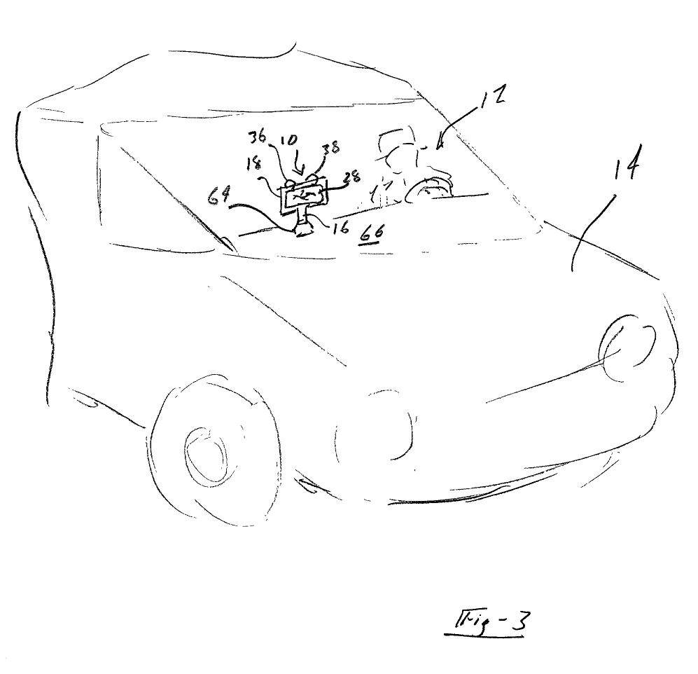

Referring now to FIG. 1, a hand-held signal display device is illustrated at 10 according to a first preferred embodiment of the present invention. Referring further to the environmental view of FIG. 3 (and which illustrates one specific application of the present invention), the signal display device 10 is for use by a driver 12 or other occupant of a vehicle 14 and in order to communicate desired messages to the drivers or occupants of other vehicles (not shown) during specific driving situations. As again was previously described, the present invention is admittedly a “low-tech” approach to accomplishing inter-vehicle communication, however one that has been demonstrated to be very effective in accomplishing the desired communication, with the advantage that it decreases the instances of driver frustration, road rage and overall better attitudes of drivers when on the road.

With reference again to FIG. 1, the hand held display device 10 includes a support with a handle portion 16 and an interconnecting and substantially planar display portion 18. In the preferred variant, the handle and display portions of the support are constructed of an integrally formed material (typically molded or casted) and such as a polymer or plasticized resin. The display portion 18 farther includes first surface 20 and a second oppositely facing surface 22 defining therebetween a specified thickness 24.

A plurality of individual and stackable sheets of material 26 are provided. Each of the sheets displays a selected message on at least one side thereof and which is according to a selected content, coloring and lettering style. Such a selected message is illustrated at 28 (according to one desired material content) and which is succeeded by any plurality of additional messages sequentially stacked beneath the selected message 28.

In a preferred variant, each of the sheets of material 26 are constructed of a semi-rigid poster board material. As previously explained, it is important that the display portion 18 and messages 26 supported thereon are of a sufficient size and dimension so that the content of the messages (such as again is illustrated by selected message 28) is easily visible to surrounding motorists. Therefore, and in a preferred construction, a six inch height and a twelve inch width have found to be most effective in both the ease of manipulation of the device by the user 12 within the vehicle 14, as well as being visible to occupants in the vehicle or vehicles (again not shown) being signaled.

Referring again to FIG. 1, the sheets are pivotally bound to the planar display portion of the support so that the selected message (such as again at 28), displayed on a first selected sheet located upon the first surface, may be rotated to abut against the second oppositely facing surface 22 and to reveal an underlying and second selected sheet located upon the first surface and displaying a further selected message. The direction of the pivotal rotation is indicated by arrow 30 in FIG. 1 and the underlying messages are illustrated at 32, 34, et. seq. in FIG. 1 in succeeding fashion beneath the initial message 28.

The pivotal binding of the display device requires at least one binding ring engaging through the display portion 18, between the first 20 and second 22 oppositely facing surfaces, and proximate an extending edge 35 located opposite the handle portion 16. As illustrated in the preferred variant 10 of FIG. 1, a pair of first 36 and second 38 binding rings are located at specified and spaced apart distances.

As best illustrated in FIG. 4, each of the rings 36 and 38, and which is represented by first ring 36, is separately attachable and disengageable from the display portion by a first pivotally associated and arcuately configured portion 40 and second pivotally associated and arcuately configured portion 42. A clasp 44 extends from an arcuately extending end of each of the first configured portion 40 and is receivingly engaging within an aperture 46 defined proximate an end of the second associated configured portion 42 and upon rotating the first 40 and second 42 configured portions towards each other and in an engaging position.

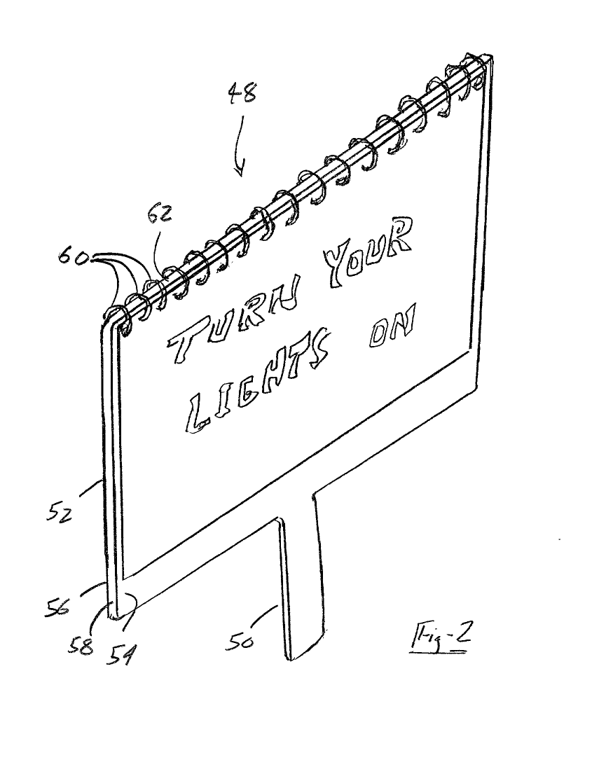

An alternative embodiment of the present invention is illustrated at 48 in FIG. 2. The embodiment 48 again includes a support with a handle portion 50 and an interconnecting and substantially planar display portion 52 with a first surface 54 and a second oppositely facing surface 56 defining therebetween a specified thickness 58. A plurality of spiral binding portions 60 are illustrated engaging through the display portion 52, between the first 54 and second 56 facing surfaces, and proximate an extending edge 62 opposite the handle portion.

Although not illustrated in the embodiment of FIG. 2, it is also envisioned that the spiral bindings can take the form of a continuously curled and elongate extending strip which is bound through an associated plurality of spaced apertures defined proximate the top extending edge 62. It is also envisioned that other types of circular or spiral binding may be employed without deviating from the scope of the invention.

Referring finally again to FIG. 2, an additional feature of the invention also contemplates a display mount 64 at a specified location within the vehicle, such as upon a top surface of dashboard 66 or other fixed location which is easily and safely accessible by the operator or other occupant in the vehicle 14. The display mount 64 may seatingly engage the handle portion (such as portion 16 of first variant 10) and so that the message arrayed upon the display portion is visible to occupants of other vehicles. This is in addition to the first preferred embodiment in which the placard display 10 or 48 is hand-held.

Having described my invention, additional preferred embodiments will become apparent to those skilled in the art to which it pertains and without deviating from the scope of the appended claims.

I claim:

1. A hand-held inter-auto display device, comprising:
a support including a handle portion and an interconnecting and substantially planar display portion, said display portion having a first surface and a second oppositely facing surface defining therebetween a specified thickness;
a plurality of individual and stackable sheets of material, each of said sheets displaying a selected message on at least one side thereof; and
said sheets being pivotally bound to said planar display portion of said support so that a selected message, displayed on a first selected sheet located upon said first surface, may be rotated to abut against said second oppositely facing surface and to reveal an underlying and second selected sheet located upon said first surface and displaying a further selected message.

2. The hand-held inter-auto display device according to claim 1, said plurality of individual and stackable sheets each further comprising a semi-rigid poster-board material.

3. The hand-held inter-auto display device according to claim 1, said pivotally binding further comprising at least one binding ring engaging through said display portion, between said first and second facing surfaces, and proximate an extending edge opposite said handle portion.

4. The hand-held inter-auto display device according to claim 3, further comprising a pair of first and second binding rings located at specified and spaced apart distances, each of said rings being separately attachable and disengageable from said display portion.

5. The hand-held inter-auto display device according to claim 4, each of said binding rings further comprising a first pivotally associated and arcuately configured portion and a second pivotally associated and arcuately configured portion, a clasp extending from an end of said first configured portion and receivingly engaging within an aperture defined proximate an end of said second configured portion.

6. The hand-held inter-auto display device according to claim 3, further comprising a plurality of spiral binding portions engaging through said display portion, between said first and second facing surfaces, and proximate an extending edge opposite said handle portion.

7. The hand-held inter-auto display device according to claim 1, further comprising a display mount at a specified location within a vehicle and within which may be seatingly engaged said handle portion.

8. The hand-held inter-auto display device according to claim 1, each of said messages being presented according to a selected content, coloring and lettering style.

9. The hand-held inter-auto display device according to claim 1, said handle portion and planar display portion comprising an integrally formed material selected from a group including polymers and plasticized resins.

10. The hand-held inter-auto display device according to claim 1, said handle portion and planar display portion being integrally constructed, each of said plurality of message bearing sheets further defining a width of substantially twelve inches and a height of substantially six inches.

11. A hand-held inter-auto display device, comprising:
a support including a handle portion and an interconnecting and substantially planar display portion, said display portion having a first surface and a second oppositely facing surface defining therebetween a specified thickness;
a plurality of individual and stackable sheets of material, each of said sheets displaying a selected message on at least one side thereof, each of said messages being presented according to a selected content, coloring and lettering style, said plurality of individual and stackable sheets each further comprising a semi-rigid poster-board material; and
said sheets being pivotally bound to said planar display portion of said support so that a selected message, displayed on a first selected sheet located upon said first surface, may be rotated to abut against said second oppositely facing surface and to reveal an underlying and second selected sheet located upon said first surface and displaying a further selected message, said pivotally binding further comprising at least one binding ring engaging through said display portion, between said first and second facing surfaces, and proximate an extending edge opposite said handle portion.

12. An inter-auto display device for use by an occupant of a first vehicle for communicating to occupants of at least one additional vehicles, said display device comprising:
a support including a first portion and an interconnecting and substantially planar display portion, said display portion having a first surface and a second oppositely facing surface defining therebetween a specified thickness;
a plurality of individual and stackable sheets of material, each of said sheets displaying a selected message on at least one side thereof, each of said messages being presented according to a selected content, coloring and lettering style, said plurality of individual and stackable sheets each further comprising a semi-rigid poster-board material;
a display mount located at a desired and exposed position within the first vehicle, said display mount be accessible by the occupant of the first vehicle and viewable by the occupants of the at least one additional vehicle; and
said sheets being pivotally bound to said planar display portion of said support so that a selected message, displayed on a first selected sheet located upon said first surface, may be rotated to abut against said second oppositely facing surface and to reveal an underlying and second selected sheet located upon said first surface and displaying a further selected message, said pivotally binding further comprising at least one binding ring engaging through said display portion, between said first and second facing surfaces, and proximate an extending edge opposite said handle portion.
